(19) United States
(12) Patent Application Publication
(10) Pub. No.: US 2024/0371081 A1
(43) Pub. Date: Nov. 7, 2024

(54) Neural Radiance Field Generative Modeling of Object Classes from Single Two-Dimensional Views

(71) Applicant: Google LLC, Mountain View, CA (US)

(72) Inventors: Mark Jeffrey Matthews, Los Angeles, CA (US); Daniel Jonathan Rebain, Vancouver (CA); Dmitry Lagun, San Jose, CA (US); Andrea Tagliasacchi, Victoria (CA)

(21) Appl. No.: 18/688,278

(22) PCT Filed: Apr. 13, 2022
(86) PCT No.: PCT/US2022/024557

§ 371 Date: Feb. 29, 2024

Related U.S. Application Data
(60) Provisional application No. 63/275,094, filed on Nov. 3, 2021.

(51) Int. Cl. G06T 15/20; G06T 15/08; G06V 10/774; G06V 40/16

(52) U.S. Cl. CPC G06T 15/20; G06T 15/08; G06V 10/774; G06V 40/168

(57) ABSTRACT

Systems and methods for learning spaces of three-dimensional shape and appearance from datasets of single-view images can be utilized for generating view renderings of a variety of different objects and/or scenes. The systems and methods can be able to learn effectively from unstructured. “in-the-wild” data, without incurring the high cost of a full-image discriminator, and while avoiding problems such as mode-dropping that are inherent to adversarial methods.

### RELATED APPLICATIONS

This application claims priority to and the benefit of U.S. Provisional Patent Application No. 63/275,094, filed Nov. 3, 2021. U.S. Provisional Patent Application No. 63/275,094 is hereby incorporated by reference in its entirety.

### FIELD

The present disclosure relates generally to neural radiance field generative modeling. More particularly, the present disclosure relates to training a generative neural radiance field model on a plurality of single views of objects or scenes for a generative three-dimensional modeling task.

### BACKGROUND

While generating realistic images may no longer be a difficult task, producing the corresponding three-dimensional structure such that they can be rendered from different views can be non-trivial. Moreover, training models for novel view synthesis may rely on a large dataset of images and camera coordinates for a singular scene. The trained model can then be limited to that singular scene for future task outputs.

Additionally, a long-standing challenge in computer vision is the extraction of three-dimensional geometric information from images of the real world. This kind of three-dimensional understanding can be critical to understanding the physical and semantic structure of objects and scenes but achieving it remains a very challenging problem. Some existing techniques in this area may either be focused on deriving geometric understanding from more than one view, or by using known geometry to supervise the learning of geometry from single views.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for generative neural radiance field model training. The method can include obtaining a plurality of images. The plurality of images can depict a plurality of different objects that belong to a shared class. The method can include processing the plurality of images with a landmark estimator model to determine a respective set of one or more camera parameters for each image of the plurality of images. In some implementations, determining the respective set of one or more camera parameters can include determining a plurality of two-dimensional landmarks in each image. The method can include for each image of the plurality of images: processing a latent code associated with a respective object depicted in the image with a generative neural radiance field model to generate a reconstruction output, evaluating a loss function that evaluates a difference between the image and the reconstruction output, and adjusting one or more parameters of the generative neural radiance field model based at least in part on the loss function. In some implementations, the reconstruction output can include a volume rendering generated based at least in part on the respective set of one or more camera parameters for the image.

In some implementations, the method can include processing the image with a segmentation model to generate one or more segmentation outputs, evaluating a second loss function that evaluates a difference between the one or more segmentation outputs and the reconstruction output, and adjusting one or more parameters of the generative neural radiance field model based at least in part on the second loss function. The method can include adjusting one or more parameters of the generative neural radiance field model based at least in part on a third loss. In some implementations, the third loss can include a term for incentivizing hard transitions.

In some implementations, the method can include evaluating a third loss function that evaluates an alpha value of the reconstruction output. The alpha value can be descriptive of one or more opacity values of the reconstruction output. The method can include adjusting one or more parameters of the generative neural radiance field model based at least in part on the third loss function. The shared class can include a faces class. A first object of the plurality of different objects can include a first face associated with a first person, and a second object of the plurality of different objects can include a second face associated with a second person.

In some implementations, the shared class can include a cars class, a first object of the plurality of different objects can include a first car associated with a first car type, and a second object of the plurality of different objects can include a second car associated with a second car type. The plurality of two-dimensional landmarks can be associated with one or more facial features. In some implementations, the generative neural radiance field model can include a foreground model and a background model. The foreground model can include a concatenation block.

Another example aspect of the present disclosure is directed to a computer-implemented method for generating class-specific view rendering outputs. The method can include obtaining, by a computing system, a training dataset. The training dataset can include a plurality of single-view images. The plurality of single-view images can be descriptive of a plurality of different respective scenes. The method can include processing, by the computing system, the training dataset with a machine-learned model to train the machine-learned model to learn a volumetric three-dimensional representation associated with a particular class. In some implementations, the particular class can be associated with the plurality of single-view images. The method can include generating, by the computing system, a view rendering based on the volumetric three-dimensional representation.

In some implementations, the view rendering can be associated with the particular class, and the view rendering can be descriptive of a novel scene that differs from the plurality of different respective scenes. The view rendering can be descriptive of a second view of a scene depicted in at least one of the plurality of single-view images. The method can include generating, by the computing system, a learned latent table based at least in part on the training dataset, and the view rendering can be generated based on the learned latent table. In some implementations, the machine-learned model can be trained based at least in part on a red-green-blue loss, a segmentation mask loss, and a hard surface loss. The machine-learned model can include an auto-decoder model.

Another example aspect of the present disclosure is directed to a computer-implemented method for generating a novel view of an object. The method can include obtaining input data. The input data can include a single-view image. In some implementations, the single-view image can be descriptive of a first object of a first object class. The method can include processing the input data with a machine-learned model to generate a view rendering. The view rendering can include a novel view of the first object that differs from the single-view image. In some implementations, the machine-learned model can be trained on a plurality of training images associated with a plurality of second objects associated with the first object class. The first object and the plurality of second objects can differ. The method can include providing the view rendering as an output.

In some implementations, the input data can include a position and a view direction, and the view rendering can be generated based at least in part on the position and the view direction. The machine-learned model can include a landmark model, a foreground neural radiance field model, and a background neural radiance field model. In some implementations, the view rendering can be generated based at least in part on a learned latent table.

In some implementations, the methods can be performed by a computing system that can include one or more processors and one or more non-transitory computer-readable media that collectively store instructions that, when executed by the one or more processors. The methods can be performed by a computing system based on one or more non-transitory computer readable media that collectively store instructions that, when executed by the one or more processors. In some implementations, a machine-learned model can be trained using the systems and methods disclosed herein.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs novel view rendering according to example embodiments of the present disclosure.

FIG. 1B depicts a block diagram of an example computing device that performs novel view rendering according to example embodiments of the present disclosure.

FIG. 1C depicts a block diagram of an example computing device that performs novel view rendering according to example embodiments of the present disclosure.

FIG. 2 depicts a block diagram of an example machine-learned model according to example embodiments of the present disclosure.

FIG. 3 depicts a block diagram of an example training and testing system according to example embodiments of the present disclosure.

FIG. 4 depicts a flow chart diagram of an example method to perform model training according to example embodiments of the present disclosure.

FIG. 5 depicts a flow chart diagram of an example method to perform view rendering generation according to example embodiments of the present disclosure.

FIG. 6 depicts a flow chart diagram of an example method to perform view rendering generation according to example embodiments of the present disclosure.

FIG. 7 depicts an illustration of example landmark estimator model outputs according to example embodiments of the present disclosure.

Reference numerals that are repeated across plural figures are intended to identify the same features in various implementations.

### DETAILED DESCRIPTION

### Overview

Generally, the present disclosure can be directed to training a generative neural radiance field model with single-view image datasets of objects and/or scenes. The systems and methods disclosed herein can leverage the plurality of single-view image datasets of the object class or scene class in order to learn a volumetric three-dimensional representation. The volumetric three-dimensional modeling representation can then be utilized to generate one or more view renderings. The view renderings can be novel views of objects or scenes in the training image datasets and/or may be a view rendering of an object or scene not depicted in the training datasets (e.g., a novel face generated based on learned features from image datasets depicting different faces).

The systems and methods disclosed herein can include obtaining a plurality of images. The plurality of images can each respectively depict one of a plurality of different objects that belong to a shared class. For each image of the plurality of images, the image can be processed with a landmark estimator model to determine a respective set of one or more camera parameters for the image. The camera parameters may include, for example, a position in the environment and a view direction of the camera. In some implementations, determining the respective set of one or more camera parameters can include determining one or more two-dimensional landmarks in the image (e.g., in some implementations, three or more two-dimensional landmarks may be determined, which can then be utilized for accurate camera parameter determination). The one or more two-dimensional landmarks can be one or more landmarks associated with the shared class. A latent code associated with the respective object depicted in the image can be processed with a generative neural radiance field model to generate a reconstruction output. The latent code may correspond to a representation of an object within the latent space. For example, the latent code may be a vector within the latent space. In some implementations, the reconstruction output can include a volume rendering generated based at least in part on the respective set of one or more camera parameters for the image. The systems and methods can include evaluating a loss function that evaluates a difference between the image and the reconstruction output and adjusting one or more parameters of the generative neural radiance field model based at least in part on the loss function.

For example, the systems and methods disclosed herein can include obtaining a plurality of images. In some implementations, one or more first images of the plurality of images can include a first object of a first object class, and one or more second images of the plurality of images can include a second object of the first object class. The first object and the second object can be different objects. In some implementations, the first object and the second object can be objects of a same object class (e.g., the first object can be a regulation high school football, and the second object can be a regulation college football). The systems and methods can include processing the plurality of images with a landmark estimator model to determine one or more camera parameters. Determining the one or more camera parameters can include determining a plurality of two-dimensional landmarks (e.g., three or more two-dimensional landmarks) in the one or more first image datasets. The one or more two-dimensional landmarks can then be processed with an fitting model to determine the camera parameters. A latent code (e.g., a latent code from a learned latent table) can be processed with a generative neural radiance field model to generate a reconstruction output. The systems and methods can then include evaluating a loss function that evaluates a difference between the one or more first images and the reconstruction output and adjusting one or more parameters of the generative neural radiance field model based at least in part on the loss function.

In some implementations, the systems and methods can include processing the one or more first images with a segmentation model to generate one or more segmentation outputs. The systems and methods can then evaluate a second loss function that evaluates a difference between the one or more segmentation outputs and the reconstruction output and adjust one or more parameters of the generative neural radiance field model based at least in part on the second loss function. Additionally and/or alternatively, the systems and methods may adjust one or more parameters of the generative neural radiance field model based at least in part on a third loss. The third loss can include a term for incentivizing hard transitions.

In some implementations, the systems and methods can include obtaining a training dataset. The training dataset can include a plurality of single-view images, and the plurality of single-view images can be descriptive of a plurality of different respective scenes. The systems and methods can include processing the training dataset with a machine-learned model to train the machine-learned model to learn a volumetric three-dimensional representation associated with a particular class. The particular class can be associated with the plurality of single-view images. In some implementations, the systems and methods can include generating a view rendering based on the volumetric three-dimensional representation. The view rendering can be associated with the particular class, and the view rendering may be descriptive of a novel scene that differs from the plurality of different respective scenes. Alternatively and/or additionally, the view rendering may be descriptive of a second view of a scene depicted in at least one of the plurality of single-view images. In some implementations, a shared latent space can be generated from the plurality of training images during the training of the machine-learned model.

The systems and methods disclosed herein can be utilized to generate face renderings that can be utilized to train a face recognition model (e.g., a FaceNet model (Florian Schroff, Dmitry Kalenichenko, & James Philbin, “FaceNet: A Unified Embedding for Face Recognition and Clustering,” CVPR 2015 Open Access, (June 2015), https://openaccess.thecvf.com/content_cvpr_2015/html/Schroff_FaceNet_A_Unified_2015_CVPR_paper.html.)). For example, the systems and methods disclosed herein can include obtaining a training dataset, in which the training dataset may include a plurality of single-view images. The plurality of single-view images can be descriptive of a plurality of different respective faces. The training dataset can be processed with a machine-learned model to train the machine-learned model to learn a volumetric three-dimensional representation. In some implementations, the volumetric three-dimensional representation can be associated with one or more facial features. The volumetric three-dimensional representation can then be utilized to generate a face view rendering.

The systems and methods can train a generative neural radiance field model, which can be utilized to generate images of human faces that are not real individuals yet look realistic. The trained model can be able to generate these faces from any desired angle. In some implementations, given an image of a real face from one angle, the systems and methods may generate an image of what the face would look like from a different angle (e.g., novel view generation). The systems and methods may be utilized to learn the three-dimensional surface geometry of all generated faces.

Images generated by the trained models can be utilized to train a face recognition model (e.g., a FaceNet model), though using data that is approved for biometrics uses. The trained face recognition model can be used in a variety of tasks (e.g., face authorization for mobile phone authentication).

Systems and methods for learning a generative three-dimensional model based on neural radiance fields can be trained solely from single views of objects. The systems and methods disclosed herein may not need any multi-view data to achieve this goal. Specifically, the systems and methods can include learning to reconstruct many images aligned to an approximate canonical pose, with a single network conditioned on a shared latent space, which can be utilized to learn a space of radiance fields that models the shape and appearance of a class of objects. The systems and methods can demonstrate this by training models to reconstruct a number of object categories including humans, cats, and cars, all using datasets that contain only single views of each subject and no depth or geometry information. In some implementations, the systems and methods disclosed herein can achieve state-of-the-art results in novel view synthesis and monocular depth prediction.

The systems and methods disclosed herein can generate novel view renderings of a scene based on a single-view image of the scene. Neural radiance field (NeRF) models normally rely on multiple views of the same object. The systems and methods disclosed herein can learn from a single view of an object. For example, the systems and methods disclosed herein can leverage neural radiance fields and generative models to generate novel view renderings of objects based on a single view of the object. In particular, the machine-learned model can be trained on a plurality of training images of different objects in the object class. The machine-learned model can then process a single image of an object in the object class to generate a novel view rendering of the object. For example, the machine-learned model can learn a latent table for an entire class (e.g., all faces) instead of learning a single object in the object class (e.g., learning a singular person). In some implementations, the machine-learned model can generate view renderings of new objects (e.g., new people) that are not in the training dataset.

In some implementations, the systems and methods disclosed herein can include obtaining a plurality of images. The plurality of images can depict a plurality of different objects that belong to a shared class. One or more first images of the plurality of images can include a first object (e.g., a face of a first person) of a first object class (e.g., a face object class). One or more second images of the plurality of images can include a second object (e.g., a face of a second person) of the first object class. Additionally and/or alternatively, the first object and the second object may differ. In some implementations, each of the second images may be descriptive of different objects (e.g., different faces associated with different people) in the object class.

In some implementations, the shared class (e.g., a first object class) can include a faces class. The first object of the plurality of different objects can include a first face associated with a first person, and the second object of the plurality of different objects can include a second face associated with a second person.

In some implementations, the shared class (e.g., a first object class) can include a cars class. The first object of the plurality of different objects can include a first car associated with a first car type (e.g., a 2015 sedan made by manufacturer X), and the second object of the plurality of different objects can include a second car associated with a second car type (e.g., a 2002 coupe made by manufacturer Y).

In some implementations, the shared class (e.g., a first object class) can include a cats class. The first object of the plurality of different objects can include a first cat associated with a first cat breed, and the second object of the plurality of different objects can include a second cat associated with a second cat breed.

Although the examples above discuss two object alternatives, the systems and methods disclosed herein can leverage any number of objects of the object class in order to learn the machine-learned model(s) parameters and the latent code table.

The plurality of images can be processed with a landmark estimator model. For example, each image of the plurality of images can be processed with a landmark estimator model to determine a respective set of one or more camera parameters for the image. In some implementations, determining the respective set of one or more camera parameters can include determining a plurality of two-dimensional landmarks in the image. The plurality of two-dimensional landmarks can be associated with one or more facial features. The landmark estimator model may be trained on a per class basis to identify landmarks associated with the particular object class (e.g., a nose on a face, a headlight on a car, or a snout on a cat). The one or more landmarks can be utilized to determine an orientation of the object depicted and/or for depth determination for specific features of the object.

In some implementations, the landmark estimator model can be pre-trained for a particular object class (e.g., the first object class which can include a face class). In some implementations, the landmark estimator model may output one or more landmark points (e.g., a point for the nose, a point for each eye, and/or one or more points for a mouth). Each landmark estimator model may be trained per object class. Additionally and/or alternatively, the landmark estimator model may be trained to determine the location of five specific landmarks, which can include one nose landmark, two eye landmarks, and two mouth landmarks. In some implementations, the systems and methods can include landmark differentiation between cats and dogs. Alternatively and/or additionally, the machine-learned model(s) may be trained for joint landmark determination for both dog classes and cat classes.

In some implementations, the camera parameters can be determined using a fitting model. For example, the plurality of two-dimensional landmarks can then be processed with a fitting model to determine the one or more camera parameters. The one or more camera parameters can be associated with the respective image and stored for iterative training.

The systems and methods can include obtaining a latent code from a learned latent table. The latent code can be obtained from a latent code table that can be learned during the training of the one or more models.

In some implementations, a latent code can be processed with a generative neural radiance field model to generate a reconstruction output. The reconstruction output can include one or more color value predictions and one or more density value predictions. In some implementations, the reconstruction output can include a three-dimensional reconstruction based on a learned volumetric representation. The reconstruction output can include a volume rendering generated based at least in part on the respective set of one or more camera parameters for the image. Alternatively and/or additionally, the reconstruction output can include a view rendering. The generative neural radiance field model can include a foreground model (e.g., a foreground neural radiance field model) and a background model (e.g., a background neural radiance field model). In some implementations, the foreground model can include a concatenation block. The foreground model may be trained for the particular object class, while the background model may be trained separately as backgrounds may differ between different object class instances. In some implementations, the accuracy of predicted renderings may be evaluated on an individual pixel basis. Therefore, the systems and methods can be scaled to arbitrary image sizes without any increase in memory requirement during training.

In some implementations, the reconstruction output can include a volume rendering generated based at least in part on the one or more camera parameters. For example, the one or more camera parameters can be utilized to associate each pixel with a ray used to compute sample locations.

The reconstruction output can then be utilized to adjust one or more parameters of the generative neural radiance field model. In some implementations, the reconstruction output can be utilized to learn a latent table.

For example, the systems and methods can evaluate a loss function (e.g., a red-green-blue loss or a perceptual loss) that evaluates a difference between the image and the reconstruction output and adjusts one or more parameters of the generative neural radiance field model based at least in part on the loss function.

In some implementations, the systems and methods can include processing the image with a segmentation model to generate one or more segmentation outputs. The foreground may be the object of interest for the image segmentation model. The segmentation output can include one or more segmentation masks. In some implementations, the segmentation output can be descriptive of the foreground object being rendered.

A second loss function (e.g., a segmentation mask loss) can then be evaluated. The second loss function can evaluate a difference between the one or more segmentation outputs and the reconstruction output. One or more parameters of the generative neural radiance field model can then be adjusted based at least in part on the second loss function. The second loss function may be utilized to determine one or more latent codes for the latent code table.

Additionally and/or alternatively, the systems and methods can include adjusting one or more parameters of the generative neural radiance field model based at least in part on a third loss (e.g., a hard surface loss). The third loss can include a term for incentivizing hard transitions.

Alternatively and/or additionally, the systems and methods can include evaluating a third loss function that evaluates an alpha value of the reconstruction output. The alpha value can be descriptive of one or more opacity values of the reconstruction output. One or more parameters of the generative neural radiance field model can be adjusted based at least in part on the third loss function.

In some implementations, the third loss function can be a hard surface loss. The hard surface loss can incentivize modeling hard surfaces over partial artifacts in a rendering. For example, the hard surface loss can encourage the alpha values (e.g., opacity values) to be either 0 (e.g., no opacity) or 1 (e.g., fully opaque). In some implementations, the alpha value can be based on optical density and distance traveled per sample.

The systems and methods can be utilized for generating class-specific view rendering outputs. In some implementations, the systems and methods can include obtaining a training dataset. The training dataset can include a plurality of single-view images. The plurality of single-view images can be descriptive of a plurality of different respective scenes. The training dataset can be processed with a machine-learned model to train the machine-learned model to learn a volumetric three-dimensional representation associated with a particular class (e.g., a faces class, a cars class, a cats class, a buildings class, a dogs class, etc.). In some implementations, the particular class can be associated with the plurality of single-view images. A view rendering can be generated based on the volumetric three-dimensional representation.

For example, the systems and methods can obtain a training dataset. In some implementations, the training dataset can include a plurality of single-view images (e.g., images of a face, car, or cat from a frontal view and/or side view). The plurality of single-view images can be descriptive of a plurality of different respective scenes. In some implementations, the plurality of single-view images can be descriptive of a plurality of different respective objects of a particular object class (e.g., a faces class, a cars class, a cats class, a dogs class, a trees class, a buildings class, a hands class, a furniture class, an apples class, etc.).

The training dataset can then be processed with a machine-learned model (e.g., a machine-learned model including a generative neural radiance field model) to train the machine-learned model to learn a volumetric three-dimensional representation associated with a particular class. In some implementations, the particular class can be associated with the plurality of single-view images. The volumetric three-dimensional representation can be associated with shared geometric properties of objects in the respective object class.

A shared latent space can be generated for the plurality of single-view images during the training of the machine-learned model. The shared latent space can include shared latent vectors associated with geometry values of an object class. The shared latent space can be constructed by determining latent values for each image in the dataset. In some implementations, the systems and methods can associate a multidimensional vector with each image and by virtue of sharing the same network, the plurality of multidimensional vectors share the same vector space. Before training, the vector space can be a somewhat arbitrary space. However after training, the vector space can be a latent space of data with learned properties. Additionally and/or alternatively, the training of the machine-learned model can enable informed shared latent space utilization for tasks such as instance interpolation.

The machine-learned model can be trained based at least in part on a red-green-blue loss (e.g., a first loss), a segmentation mask loss (e.g., a second loss), and/or a hard surface loss (e.g., a third loss). In some implementations, the machine-learned model can include an auto-decoder model, a vector quantized variational autoencoder, and/or one or more neural radiance field models. The machine-learned model can be a generative neural radiance field model.

A view rendering can be generated based on the volumetric three-dimensional representation. In some implementations, the view rendering can be associated with the particular class generated by the machine-learned model using a learned latent table. The view rendering can be descriptive of a novel scene that differs from the plurality of different respective scenes. In some implementations, the view rendering can be descriptive of a second view of a scene depicted in at least one of the plurality of single-view images.

In some implementations, the systems and methods can include generating a learned latent table for at least part of the training dataset. The view rendering can be generated based on the learned latent table. For example, the machine-learned model may sample from the learned latent table in order to generate the view rendering. Alternatively and/or additionally, one or more latent code outputs may be obtained in response to a user input (e.g., a position input, a view direction input, and/or an interpolation input). The obtained latent code outputs may then be processed by the machine-learned model(s) to generate the view rendering. In some implementations, the learned latent table can include a shared latent space learned based on latent vectors associated with the object class of the training dataset. The latent code mapping can include a one to one relationship between latent values and images. The shared latent space can be utilized for space-aware new object generation (e.g., an object in the object class, but not in the training dataset, can have a view rendering generated by selecting one or more values from the shared latent space). For example, the training dataset can be utilized to train a generative neural radiance field model, which can be trained to generate view renderings based on latent values. An image of a new object from the object class can then be received with an input requesting a novel view of the new object. The systems and methods disclosed herein can process the image of the new object to regress, or determine, one or more latent code values for the new object. The one or more latent codes can be processed by the generative neural radiance field model to generate the novel view rendering.

Systems and methods for novel view rendering with an object class trained machine-learned model can include obtaining an input dataset. The input dataset can include a single-view image. In some implementations, the single-view image can be descriptive of a first object of a first object class. The input dataset can be processed with a machine-learned model to generate a view rendering. The view rendering can include a novel view of the first object that differs from the single-view image. In some implementations, the machine-learned model may have been trained on a plurality of training images associated with a plurality of second objects associated with the first object class. The first object and the plurality of second objects may differ. The systems and methods can include providing the view rendering as an output.

In some implementations, the systems and methods can include obtaining input data. The input data can include a single-view image. The single-view image can be descriptive of a first object (e.g., a face of a first person) of a first object class (e.g., a face class, a car class, a cat class, a dog class, a hands class, a sports balls class, etc.). In some implementations, the input data can include a position (e.g., a three-dimensional position associated with an environment that includes the first object) and a view direction (e.g., a two-dimensional view direction associated with the environment). Alternatively and/or additionally, the input data may include solely a single input image. In some implementations, the input data may include an interpolation input to instruct the machine-learned model to generate a new object not in the training dataset of the machine-learned model. The interpolation input can include specific characteristics to include in the new object interpolation.

The input data can be processed with a machine-learned model to generate a view rendering. In some implementations, the view rendering can include a novel view of the first object that differs from the single-view image. The machine-learned model may be trained on a plurality of training images associated with a plurality of second objects associated with the first object class (e.g., a shared class). In some implementations, the first object and the plurality of second objects may differ. Alternatively and/or additionally, the view rendering can include a new object that differs from the first object and the plurality of second objects.

In some implementations, the input data can include a position (e.g., a three-dimensional position associated with the environment of the first object) and a view direction (e.g., a two-dimensional view direction associated with the environment of the first object), and the view rendering can be generated based at least in part on the position and the view direction.

In some implementations, the machine-learned model can include a landmark estimator model, a foreground neural radiance field model, and a background neural radiance field model.

In some implementations, the view rendering can be generated based at least in part on a learned latent table.

The systems and methods can include providing the view rendering as output. In some implementations, the view rendering can be output for display on a display element of a computing device. The view rendering may be provided for display in a user interface of a view rendering application. In some implementations, the view rendering may be provided with a three-dimensional reconstruction.

The systems and methods can include least squares fitting for camera parameters for image fitting to learn a camera angle for an input image.

In some implementations, the systems and methods disclosed herein can include camera fitting based on a landmark estimator model, a latent table learned per object class, and a combination loss including a red-green-blue loss, a segmentation mask loss, and a hard surface loss. In some implementations, the systems and methods can use principal component analysis to select new latent vectors to create new identities.

The systems and methods of the present disclosure provide a number of technical effects and benefits. As one example, the system and methods can train a generative neural radiance field model for generating view synthesis renderings. More specifically, the systems and methods can utilize single-view image datasets in order to train the generative neural radiance field model to generate view renderings for the trained object class (i.e., the shared class) or scene class. For example, in some implementations, the systems and methods can include training the generative neural radiance field model on a plurality of single-view image datasets for a plurality of different respective faces. The generative neural radiance field model can then be utilized to generate a view rendering of a new face, which may not have been included in the training datasets.

Another technical benefit of the systems and methods of the present disclosure is the ability to generate view renderings without relying on explicit geometric information (e.g., depths or point clouds). For example, the models may be trained on a plurality of image datasets in order to train the model to learn a volumetric three-dimensional representation, which can then be utilized for view rendering of an object class.

Another example technical effect and benefit relates to learning the three-dimensional modeling based on a set of approximately calibrated, single-view images with a network conditioned on a shared latent space. For example, the systems and methods can approximately align the dataset to a canonical pose using two-dimensional landmarks, which can then be used to determine from which view the radiance field should be rendered to reproduce the original image.

With reference now to the Figures, example embodiments of the present disclosure will be discussed in further detail.

### Example Devices and Systems

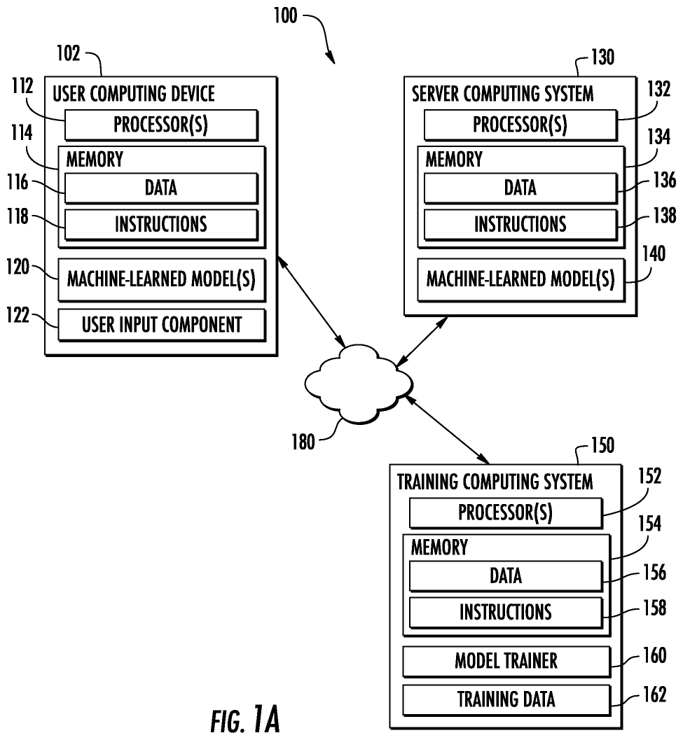

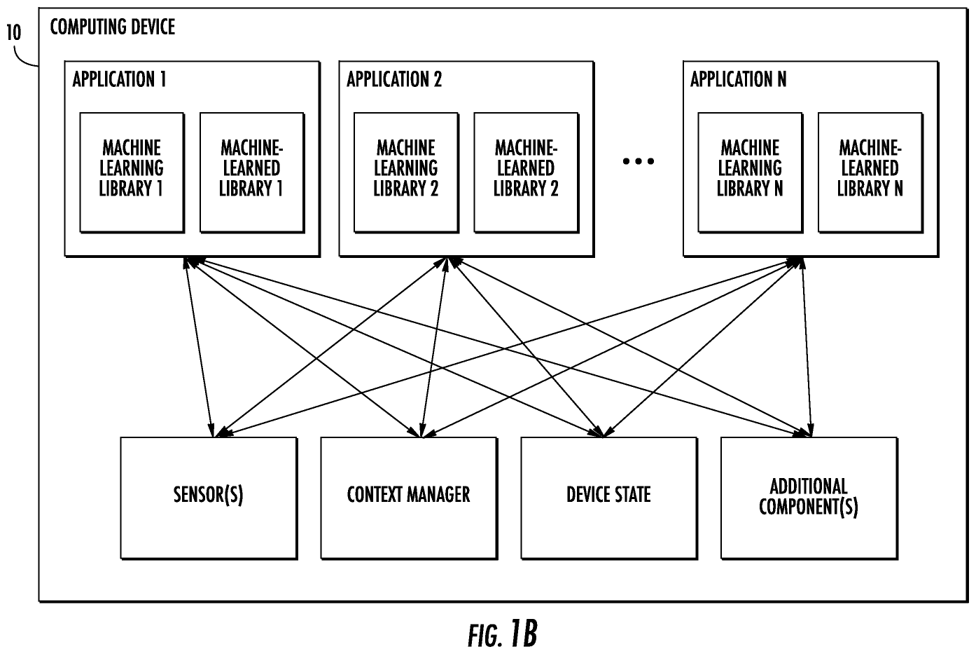

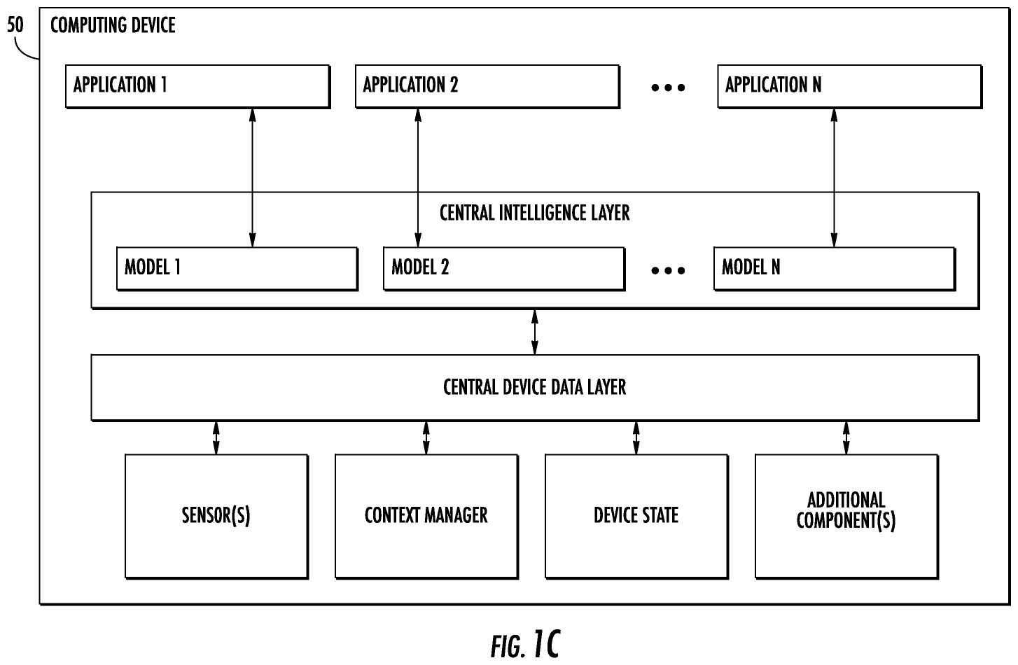

FIG. 1A depicts a block diagram of an example computing system 100 that performs view rendering according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

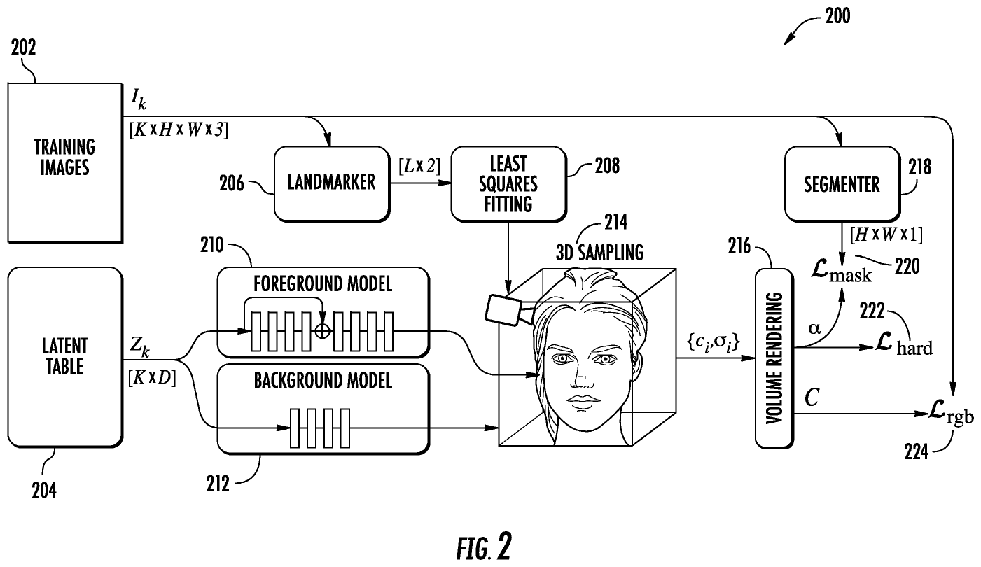

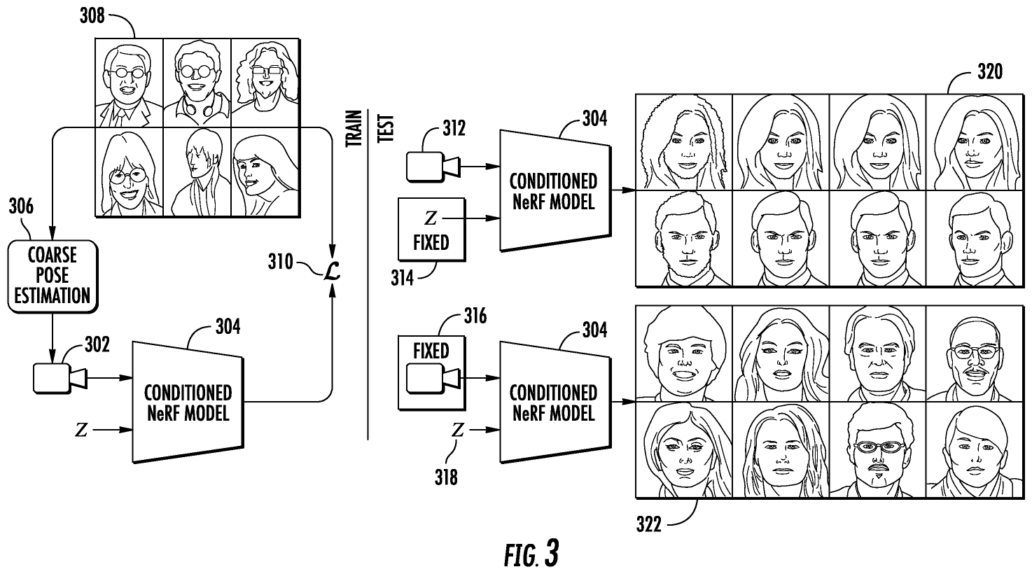

In some implementations, the user computing device 102 can store or include one or more generative neural radiance field models 120. For example, the generative neural radiance field models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example generative neural radiance field models 120 are discussed with reference to FIGS. 2-3.

In some implementations, the one or more generative neural radiance field models 120 can be received from the server computing system 130 over network 180, stored in the user computing device memory 114, and then used or otherwise implemented by the one or more processors 112. In some implementations, the user computing device 102 can implement multiple parallel instances of a single generative neural radiance field model 120 (e.g., to perform parallel view renderings across multiple instances of view rendering requests).

More particularly, the generative neural radiance field model can be trained with a plurality of image datasets. Each image dataset can include image data descriptive of a singular image of a singular view of an object or scene in which each scene and/or object may be different. The trained generative neural radiance field model can then be utilized for novel view rendering based on being trained on a class of objects or scenes.

Additionally or alternatively, one or more generative neural radiance field models 140 can be included in or otherwise stored and implemented by the server computing system 130 that communicates with the user computing device 102 according to a client-server relationship. For example, the generative neural radiance field models 140 can be implemented by the server computing system 140 as a portion of a web service (e.g., a view rendering service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned generative neural radiance field models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the generative neural radiance field models 120 and/or 140 based on a set of training data 162. The training data 162 can include, for example, a plurality of image datasets in which each image dataset is descriptive of a single view of a different object or scene, in which each object or scene is of a same class.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

In some implementations, the systems and methods disclosed herein can utilize a tensor processing unit (TPU). For example, the systems and methods can utilize a TPU (e.g., Google's Cloud TPU (“Cloud TPU,” Google Cloud, (Mar. 4, 2022, 12:45 PM), https://cloud.google.com/tpu)) to train the one or more machine-learned models.

### Example Model Arrangements

FIG. 2 depicts a block diagram of an example machine-learned model 200 according to example embodiments of the present disclosure. In some implementations, the machine-learned model 200 is trained to receive a set of input data 202 descriptive of one or more training images and, as a result of receipt of the input data 202, provide output data 216 that can be descriptive of predicted density values and predicted color values. Thus, in some implementations, the machine-learned model 200 can include a generative neural radiance field model, which can include a foreground model 210 and a background model 212 that are operable to generate predicted color values and predicted density values based at least in part on a latent table 204.

FIG. 2 depicts a block diagram of an example machine-learned model 200 according to example embodiments of the present disclosure. For example, the systems and methods can learn a per-image table of latent codes (e.g., the latent table 204) alongside foreground and background NeRFs (e.g., a foreground model 210 and background model 212). A volumetric rendering output (e.g., output data 216 which can include a volume rendering) may be subject to a per-ray RGB loss 224 against each training pixel, and an alpha value against an image segmenter (e.g., an image segmentation model 218). Camera alignments may be derived from a least-squares fit 208 of two-dimensional landmarker outputs to class-specific canonical three-dimensional keypoints.

In particular, the machine-learned model 200 can include a foreground model 210 and a background model 212 for predicting color values and density values to be utilized for view rendering. The foreground model 210 may be trained separately from the background model 212. For example, in some implementations, the foreground model 210 may be trained on a plurality of images descriptive of different objects in a particular object class. In some implementations, the foreground model 210 and/or the background model 212 may include a neural radiance field model. Additionally and/or alternatively, the foreground model 210 can include a residual connection or a skip connection. In some implementations, the foreground model 210 can include a concatenation block for the connection.

The machine-learned model 200 can obtain one or more training images 202. The training images 202 can be descriptive of one or more objects in a particular object class (e.g., faces in a face class, cars in a car class, etc.). The training images 202 can be processed by a landmark estimator model 206 to determine one or more landmark points associated with features in the training images. The features can be associated with characterizing features of objects in the object class (e.g., noses on faces, headlights on a car, or eyes on a cat). In some implementations, the landmark estimator model 206 may be pre-trained for the particular object class. The one or more landmark points can then be processed by a camera fitting block 208 to determine the camera parameters for the training images 202.

The camera parameters and a latent table 204 can then be utilized for view rendering. For example, one or more latent codes can be obtained from the latent table 204. The latent codes can be processed by the foreground model 210 and the background model 212 to generate a foreground output (e.g., one or more foreground predicted color values and one or more foreground predicted density values) and a background output (e.g., one or more background predicted color values and one or more background predicted density values). The foreground output and the background output can be utilized to generate a three-dimensional representation 214. In some implementations, the three-dimensional representation 214 may be descriptive of an object from a particular input image. The three-dimensional representation 214 can then be utilized to generate a volume rendering 216 and/or a view rendering. In some implementations, the volume rendering 216 and/or the view rendering may be generated based at least in part on one or more camera parameters determined using the landmark estimator model 206 and the fitting model 208. The volume rendering 216 and/or the view rendering can then be utilized to evaluate one or more losses for evaluating the performance of the foreground model 210, the background model 212, and the learned latent table 204.

For example, the color values of the volume rendering 216 and/or the view rendering can be compared against the color values of an input training image 202 in order to evaluate a red-green-blue loss 224 (e.g., the loss can evaluate the accuracy of the color prediction with respect to a ground truth color from the training image). The density values of the volume rendering 216 can be utilized to evaluate a hard surface loss 222 (e.g., the hard surface loss can penalize density values that are not associated with completely opaque or completely transparent opacity values). Additionally and/or alternatively, the volume rendering 216 may be compared against segmented data (e.g., one or more objects segmented from training images 202 using an image segmentation model 218) from one or more training images 202 in order to evaluate a segmentation mask loss 220 (e.g., a loss that evaluates the rendering of an object in a particular object class with respect to other objects in the object class).

The gradient descents generated by evaluating the losses can be backpropagated in order to adjust one or more parameters of the foreground model 210, the background model 212, and/or the landmark estimator model 206. The gradient descent may be utilized to adjust the latent code data of the latent table 204.

Alternatively and/or additionally, FIG. 2 can depict a block diagram of an example generative neural radiance field model 200 according to example embodiments of the present disclosure. In some implementations, the generative neural radiance field model 200 is trained with a set of training data 202 descriptive of a plurality of different objects via a plurality of single-view images of the different respective objects or scenes and, as a result of receipt of the training data 202, provide output data 220, 222, & 224 that includes a gradient descent output of one or more loss functions. Thus, in some implementations, the generative neural radiance field model 200 can include a foreground NeRF model 210 that is operable to predict color values and density values of one or more pixels for a foreground object.

For example, the generative neural radiance field model 200 can include a foreground model 210 (e.g., a foreground neural radiance field model) and a background model 212 (e.g., a background neural radiance field model). In some implementations, the training data 202 can be processed by a landmark estimator model 206 to determine one or more landmark points. In particular, the training data 202 can include one or more images including an object. The one or more landmark points can be descriptive of characterizing features for the object. The one or more landmark points can be processed by a camera fitting block 208 to determine the camera parameters of the one or more images of the training data 202.

The determined camera parameters and one or more latent codes from a learned latent table 204 can be processed by the foreground model 210 to generate predicted color values and predicted density values for the object. Additionally and/or alternatively, the determined camera parameters and one or more latent codes from a learned latent table 204 can be processed by the background model 212 to generate predicted color values and predicted density values for the background.

The predicted color values and predicted density values for the foreground and the background can be concatenated and then utilized for training the machine-learned model(s) or learning the latent table 204. For example, the predicted color values and the predicted density values can be processed by a composite block 216 to generate a reconstruction output, which can be compared against one or more images from the training data 202 in order to evaluate a red-green-blue loss 224 (e.g., a perceptual loss). Additionally and/or alternatively, one or more images from the training data 202 can be processed with an image segmentation model 218 to segment the object. The segmentation data and the predicted color values and predicted density values can be compared to evaluate a segmentation mask loss 220. In some implementations, the predicted density values and the predicted color values can be utilized to evaluate a hard surface loss 222 function that evaluates the prediction of hard surfaces. For example, the hard surface loss 222 may penalize opacity values (e.g., opacity values determined based on the one or more predicted density values) that are not 0 or 1.

Each of the losses individually, or in combination, may be utilized to generate a gradient descent which can be backpropagated to adjust one or more parameters of the foreground model or the background model. Alternatively and/or additionally, the gradient descent may be utilized to generate and/or update one or more items in the latent table 204.

FIG. 3 depicts a block diagram of an example training and testing system 300 according to example embodiments of the present disclosure. For example, the systems and methods can learn a space of shape and appearance by reconstructing a large collection of single-view images 308 using a single neural network conditioned on a shared latent space (left). The conditioned network can allow for a volumetric three-dimensional model to be lifted from the image and rendered from novel viewpoints (right).

In particular, a generative neural radiance field model 304 can be trained using a large collection of single-view images 308. In some implementations, each of the images of the large collection of single-view images 308 can be descriptive of different objects in a particular object class. Additionally and/or alternatively, the different objects may be captured from differing views (e.g., one or more images may be descriptive of a right side of the objects, while one or more images may be descriptive of a frontal view of different objects). The training can include processing each of the images to determine a canonical pose of each of the images. For example, the images can be processed by a coarse pose estimation model 306. The coarse pose estimation model 306 can include a landmark estimator model for determining one or more landmark points, which can then be utilized to determine the camera parameters of each image based on derivation from a least-squares fit of two-dimensional landmarker outputs to class-specific canonical three-dimensional keypoints.

Additionally and/or alternatively, training can include processing input data 302 (e.g., camera parameters and latent codes) with the generative neural radiance field model 304 to generate an output (e.g., a view rendering). The output can then be compared against one or more of the images from the large collection of single-view images 308 in order to evaluate a loss function 310. The evaluation can then be utilized to adjust one or more parameters of the generative neural radiance field model 304.

The trained generative neural radiance field model 304 can then be tested by either fixing the latent codes 314 and varying the camera parameters 312 or by fixing the camera parameters 316 and varying the latent codes 318. Fixing the latent codes 314 but varying the camera parameters 312 being input into the generative neural radiance field model 304 can lead to the generation of different views of particular objects 320 based on a learned volumetric three-dimensional model of the particular objects. Alternatively, fixing the camera parameters 316 (e.g., the position in the environment and the view direction) but varying the latent code 318 can allow for the generative neural radiance field model to display the performance of view renderings for different objects in the object class 322.

FIG. 3 depicts a block diagram of an example generative neural radiance field model 300 according to example embodiments of the present disclosure. The generative neural radiance field model 300 is similar to the generative neural radiance field model 200 of FIG. 2 except that the generative neural radiance field model 300 is specifically trained on single-view image datasets of faces.

More specifically, FIG. 3 depicts a block diagram of an example generative neural radiance field model 300 according to example embodiments of the present disclosure. In some implementations, the generative neural radiance field model 300 is trained to receive a set of input data 308 descriptive of a single-view image datasets of different faces and, as a result of receipt of the input data 308, provide output data that is descriptive of a novel view rendering generated based on a generated latent three-dimensional model. Thus, in some implementations, the generative neural radiance field model 300 can include a trained facial NeRF model 302 that is operable to generate novel view renderings of different faces based on a learned object class of faces.

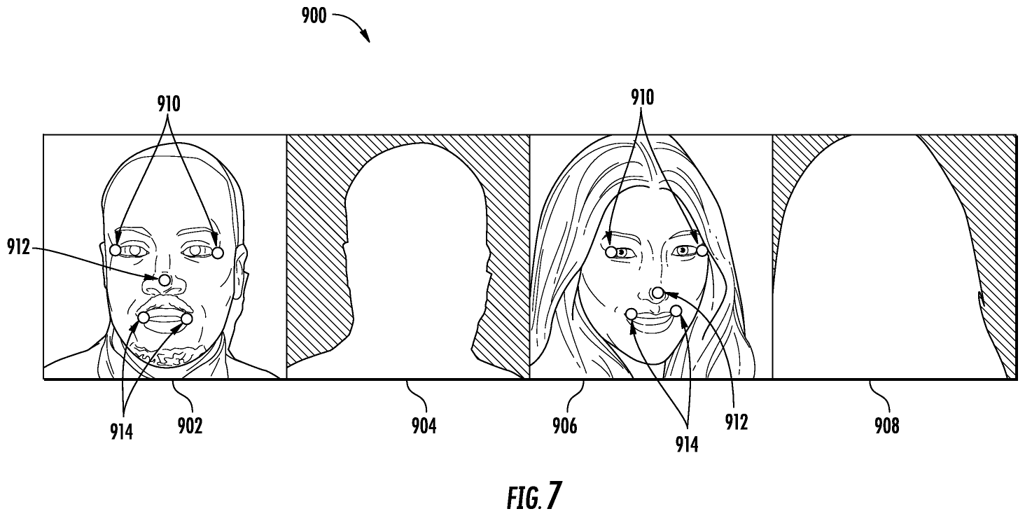

FIG. 7 depicts an illustration of example landmark estimator model outputs 900 according to example embodiments of the present disclosure. The landmark estimator model and the image segmentation model can be utilized to generate the depicted outputs. The sample outputs from the landmarker and the segmenter networks for the two input identities can convey the location of the foreground object and the location of specific characterizing features. The dots can denote the identified landmarks.

In particular, images 902 & 906 can be descriptive of the input images (e.g., training images) with five landmark points annotated on the images 902 & 906. The input images can be input into the landmark estimator model to generate the images 902 & 906. The five landmark points can include two eye landmarks 910, a nose landmark 912, and two mouth landmarks 914. In some implementations, there may be more landmarks, and in other implementations, there may be less landmarks. The landmarks can be utilized to determine the camera parameters of the input images.

FIG. 7 further depicts a segmentation mask 904 & 908 for each input image. The segmentation masks 904 & 908 can be generated by an image segmentation model that processes the input images. The segmentation masks 904 & 908 can be associated with a foreground object in the input images. In some implementations, the segmentation masks 904 & 908 can isolate the object from the rest of the input image in order to evaluate the object rendering of a generated view rendering.

### Example Methods

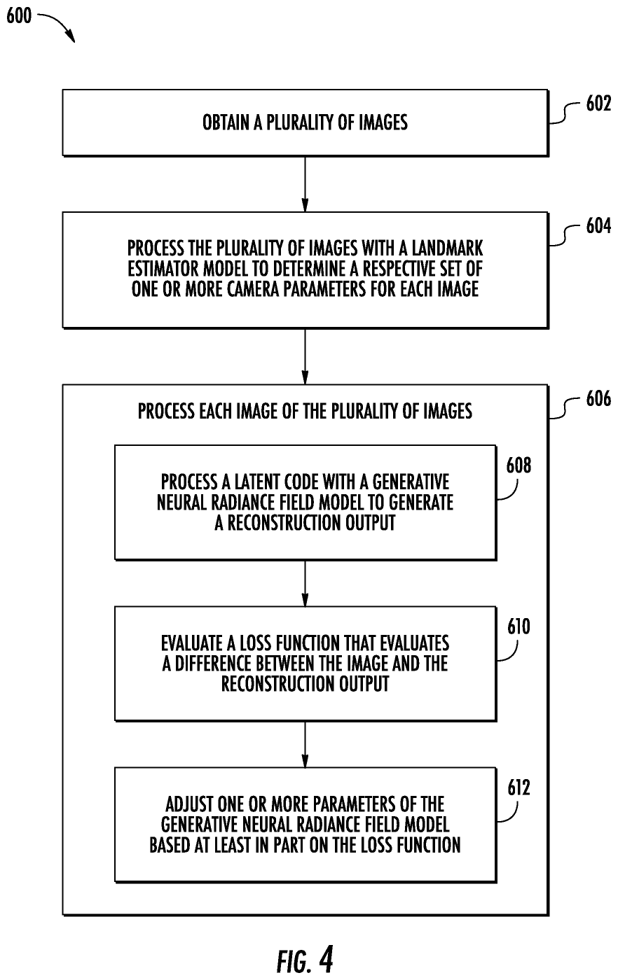

FIG. 4 depicts a flow chart diagram of an example method to perform according to example embodiments of the present disclosure. Although FIG. 4 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a plurality of images. Each image of the plurality of images can respectively depict one of a plurality of different objects that belong to a shared class. One or more first images of the plurality of images can include a first object (e.g., a face of a first person) of a shared class (e.g., a first object class (e.g., a face object class)). One or more second images of the plurality of images can include a second object (e.g., a face of a second person) of the shared class (e.g., the first object class). Additionally and/or alternatively, the first object and the second object may differ. In some implementations, each of the second images may be descriptive of different objects (e.g., different faces associated with different people) in the object class.

In some implementations, the shared class can include a faces class. The first object of the plurality of different objects can include a first face associated with a first person, and the second object of the plurality of different objects can include a second face associated with a second person.

In some implementations, the shared class can include a cars class. The first object of the plurality of different objects can include a first car associated with a first car type (e.g., a 2015 sedan made by manufacturer X), and the second object of the plurality of different objects can include a second car associated with a second car type (e.g., a 2002 coupe made by manufacturer Y).

At 604, the computing system can process the plurality of images with a landmark estimator model to determine a respective set of one or more camera parameters for each image. The respective set of one or more parameters can be a respective set of one or more parameters for each image of the plurality of images. In some implementations, determining the respective set of one or more camera parameters can include determining plurality of two-dimensional landmarks in the image. The plurality of two-dimensional landmarks can be associated with one or more facial features. The landmark estimator model may be trained on a per class basis to identify landmarks associated with the particular object class (e.g., a nose on a face, a headlight on a car, or a snout on a cat). The one or more landmarks can be utilized to determine an orientation of the object depicted and/or for depth determination for specific features of the object.

In some implementations, the landmark estimator model can be pre-trained for a particular object class (e.g., the shared class which can include a face class). In some implementations, the landmark estimator model may output one or more landmark points (e.g., a point for the nose, a point for each eye, and/or one or more points for a mouth). Each landmark estimator model may be trained per object class (e.g., for each shared class). Additionally and/or alternatively, the landmark estimator model may be trained to determine the location of five specific landmarks, which can include one nose landmark, two eye landmarks, and two mouth landmarks. In some implementations, the systems and methods can include landmark differentiation between cats and dogs. Alternatively and/or additionally, the machine-learned model(s) may be trained for joint landmark determination for both dog classes and cat classes.

In some implementations, the computing system can process the plurality of two-dimensional landmarks with an fitting model to determine the respective set of one or more camera parameters.

At 606, the computing system can process each image of the plurality of images. Each image may be processed to generate a respective reconstruction output to be evaluated against a respective image to train the generative neural radiance field model.

At 608, the computing system can process a latent code with a generative neural radiance field model to generate a reconstruction output. The latent code can be associated with a respective object depicted in the image. The reconstruction output can include one or more color value predictions and one or more density value predictions. In some implementations, the reconstruction output can include a three-dimensional reconstruction based on a learned volumetric representation. Alternatively and/or additionally, the reconstruction output can include a view rendering. The generative neural radiance field model can include a foreground model (e.g., a foreground neural radiance field model) and a background model (e.g., a background neural radiance field model). In some implementations, the foreground model can include a concatenation block. The foreground model may be trained for the particular object class, while the background model may be trained separately as backgrounds may differ between different object class instances. The foreground model and the background model may be trained for three-dimensional consistency bias. In some implementations, the accuracy of predicted renderings may be evaluated on an individual pixel basis. Therefore, the systems and methods can be scaled to arbitrary image sizes without any increase in memory requirement during training.

In some implementations, the reconstruction output can include a volume rendering and/or a view rendering generated based at least in part on the respective set of one or more camera parameters.

At 610, the computing system can evaluate a loss function that evaluates a difference between the image and the reconstruction output. In some implementations, the loss function can include a first loss (e.g., a red-green-blue loss), a second loss (e.g., a segmentation mask loss), and/or a third loss (e.g., a hard surface loss).

At 612, the computing system can adjust one or more parameters of the generative neural radiance field model based at least in part on the loss function. In some implementations, the evaluation of the loss function can be utilized to adjust one or more values of a latent encoding table.

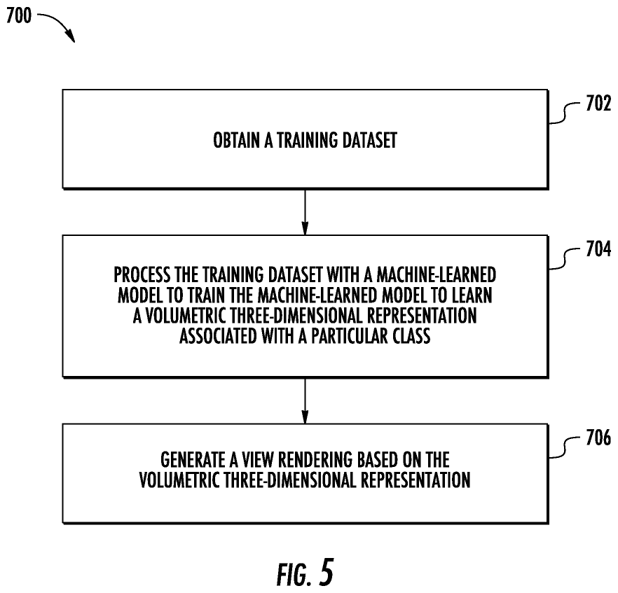

FIG. 5 depicts a flow chart diagram of an example method to perform according to example embodiments of the present disclosure. Although FIG. 5 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain a training dataset. In some implementations, the training dataset can include a plurality of single-view images (e.g., images of a face, car, or cat from a frontal view and/or side view). In some implementations, the computing system can generate a shared latent space (e.g., a shared latent vector space associated with geometry values of an object class). The plurality of single-view images can be descriptive of a plurality of different respective scenes. In some implementations, the plurality of single-view images can be descriptive of a plurality of different respective objects of a particular object class (i.e., a shared class (e.g., a faces class, a cars class, a cats class, a dogs class, a trees class, a buildings class, a hands class, a furniture class, an apples class, etc.)).

At 704, the computing system can process the training dataset with a machine-learned model to train the machine-learned model to learn a volumetric three-dimensional representation associated with a particular class. In some implementations, the particular class can be associated with the plurality of single-view images. The volumetric three-dimensional representation can be associated with shared geometric properties of objects in the respective object class. In some implementations, the volumetric three-dimensional representation can be generated based on the shared latent space that was generated from the plurality of single-view images.

The machine-learned model can be trained based at least in part on a red-green-blue loss (e.g., a first loss), a segmentation mask loss (e.g., a second loss), and/or a hard surface loss (e.g., a third loss). In some implementations, the machine-learned model can include an auto-decoder model, a vector quantized variational autoencoder, and/or one or more neural radiance field models. The machine-learned model can be a generative neural radiance field model.

At 706, the computing system can generate a view rendering based on the volumetric three-dimensional representation. In some implementations, the view rendering can be associated with the particular class and can be generated by the machine-learned model using a learned latent table. The view rendering can be descriptive of a novel scene that differs from the plurality of different respective scenes. In some implementations, the view rendering can be descriptive of a second view of a scene depicted in at least one of the plurality of single-view images.

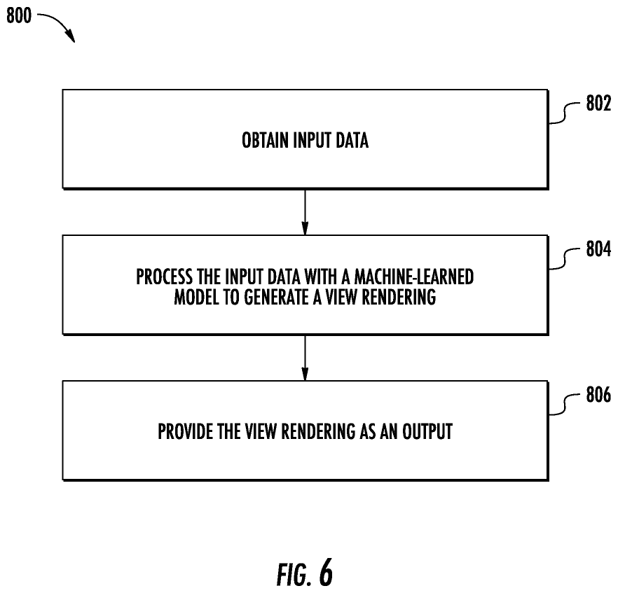

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain input data. The input data can include a single-view image. The single-view image can be descriptive of a first object (e.g., a face of a first person) of a first object class (e.g., a face class, a car class, a cat class, a dog class, a hands class, a sports balls class, etc.). In some implementations, the input data can include a position (e.g., a three-dimensional position associated with an environment that includes the first object) and a view direction (e.g., a two-dimensional view direction associated with the environment). Alternatively and/or additionally, the input data may include solely a single input image. In some implementations, the input data may include an interpolation input to instruct the machine-learned model to generate a new object not in the training dataset of the machine-learned model. The interpolation input can include specific characteristics to include in the new object interpolation.

At 804, the computing system can process the input data with a machine-learned model to generate a view rendering. In some implementations, the view rendering can include a novel view of the first object that differs from the single-view image. The machine-learned model may be trained on a plurality of training images associated with a plurality of second objects associated with the first object class. In some implementations, the first object and the plurality of second objects may differ. Alternatively and/or additionally, the view rendering can include a new object that differs from the first object and the plurality of second objects.

At 806, the computing system can provide the view rendering as an output. In some implementations, the view rendering can be output for display on a display element of a computing device. The view rendering may be provided for display in a user interface of a view rendering application. In some implementations, the view rendering may be provided with a three-dimensional reconstruction.

### Example Implementations

The systems and methods disclosed herein can derive flexible volumetric representations directly from images taken in uncontrolled environments. GAN-based methods attempt to learn a space of shapes that when rendered produce a distribution of images indistinguishable from a training distribution. However, GAN-based methods require the use of discriminator networks which are very inefficient when combined with three-dimensional representations that use volumetric representations. To avoid this limitation, the systems and methods disclosed herein can reconstruct images directly with a more efficient and scalable stochastic sampling process.

The systems and methods disclosed herein may leverage Neural Radiance Fields (NeRF) for view rendering tasks. Neural Radiance Fields can use classical volume rendering to compute radiance values for each pixel p from samples taken at points x along the associated ray. These samples can be computed using a learned radiance field which maps x, as well as the ray direction d, to radiance values c, and density values σ. The volume rendering equation can take the form a weighted sum of the radiance values at each sample point xᵢ:

$${C}_{N e R F} ( p ) = {\sum }_{i = 1}^{N} {w}_{i} \cdot c ( {x}_{i} , d ) \qquad ( 1 )$$

with the weights wᵢ being derived from an accumulation of the transmittance along the view ray xᵢ:

$${w}_{i} = ( 1 - exp ( - σ ( {x}_{i} ) {δ}_{i} ) ) \cdot exp ( - {\sum }_{j = 1}^{i - 1} σ ( {x}_{j} ) {δ}_{j} ) \qquad ( 2 )$$

where δᵢ can be the sample spacing at the i-th point. The systems and methods can denote the product of the accumulated transmittance and sample opacity as w, as this value can determine the contribution of a single sample to the final pixel value. These weights can also be used to compute other values such as surface depth (by replacing the per sample radiance values with sample depth d(xᵢ), or the overall pixel opacity:

$$D ( p ) = {\sum }_{i = 1}^{N} {w}_{i} \cdot d ( {x}_{i} ) \\ α ( p ) = {\sum }_{i = 1}^{N} {w}_{i} \cdot 1 \qquad ( 3 )$$

In some implementations, the systems and methods disclosed herein can utilize auto-decoders. Auto-decoders (i.e., Generative Latent Optimization (GLO)) are a family of generative models that learn without the use of either an encoder or discriminator. The method can work similarly to an auto-encoder, in that a decoder network can map a latent code to a final output. However, the method can differ in how these latent codes may be found (e.g., auto-decoders learn the codes directly by allocating a table of codes with a row for each distinct element in the training dataset). These codes can be co-optimized with the rest of the model parameters as learnable variables.

In particular, the systems and methods disclosed herein can include a method for learning a generative three-dimensional model based on neural radiance fields, trained solely from data with only single views of each object. While generating realistic images may no longer be a difficult task, producing the corresponding three-dimensional structure such that they can be rendered from different views is non-trivial. The systems and methods can reconstruct many images aligned to an approximate canonical pose. With a single network conditioned on a shared latent space, it is possible to learn a space of radiance fields that models shape and appearance for a class of objects. The systems and methods can demonstrate this by training models to reconstruct object categories using datasets that contain only one view of each subject without depth or geometry information. Experiments with example models can show that the systems and methods disclosed herein can achieve state-of-the-art results in novel view synthesis and competitive results for monocular depth prediction.

A challenge in computer vision can be the extraction of three-dimensional geometric information from images of the real world. Understanding three-dimensional geometry can be critical to understanding the physical and semantic structure of objects and scenes. The systems and methods disclosed herein can aim to derive equivalent three-dimensional understanding in a generative model from only single views of objects, and without relying on explicit geometric information like depth or point clouds. While Neural Radiance Field (NeRF)-based methods can show great promise in geometry-based rendering, existing methods focus on learning a single scene from multiple views.

Existing NeRF works may require supervision from more than one viewpoint, as without the multiple views, NeRF methods may be prone to collapse to a flat representation of the scene, because the methods have no incentive to create a volumetric representation. The bias can serve as a major bottleneck, as multiple-view data can be hard to acquire. Thus, architectures have been devised to work around this that can combine NeRF and Generative Adversarial Networks (GANs), where the multi-view consistency may be enforced through a discriminator to avoid the need for multi-view training data.

The systems and methods disclosed herein can utilize single views of a class of objects to train NeRF models without adversarial supervision, when a shared generative model is trained, and approximate camera poses are provided. In some implementations, the systems and methods can roughly align all images in the dataset to a canonical pose using predicted two-dimensional landmarks, which can then be used to determine from which view the radiance field should be rendered to reproduce the original image. For the generative model, the systems and methods can employ an auto-decoder framework. To improve generalization, the systems and methods can further train two models, one for the foreground (e.g., the common object class of the dataset) and one for the background, since the background may be often inconsistent throughout the data, hence unlikely to be subject to the three-dimensional-consistency bias. The systems and methods can encourage the model to model shapes as solid surfaces (i.e., sharp outside-to-inside transitions), which can further improve the quality of predicted shapes.

In some implementations, the systems and methods may not require rendering of entire images, or even patches, while training. In the auto-decoder framework, the systems and methods can train the models to reconstruct images from datasets, and at the same time find the optimal latent representations for each image—an objective that can be enforced on individual pixels. Therefore, the systems and methods can be scaled to arbitrary image sizes without any increase in memory requirement during training.

In some implementations, the systems and methods can include a scalable method for learning three-dimensional reconstruction of object categories from single-view images.

The systems and methods disclosed herein can include training network parameters and latent codes Z by minimizing the weighted sum of three losses:

$${ℒ}_{total} = {ℒ}_{r g b} + {λ}_{m a s k} {ℒ}_{m a s k} + {λ}_{hard} {ℒ}_{h a r d} \qquad ( 4 )$$

where the first term can be the red-green-blue loss (e.g., in some implementations, the red-green-blue loss can include a standard L2 photometric reconstruction loss over pixels p from the training images Iₖ):

$${ℒ}_{r g b} = {𝔼}_{k ∈ \{ 1 … K \} , p ∈ {I}_{k}} [ {( C ( p \vert {z}_{k} ) - {C}_{G T}^{k} ( p ) )}^{2} ] \qquad ( 5 )$$

The system can extend the “single-scene” (i.e., overfitting/memorization) formulation of NeRF to support learning a latent space of shapes by incorporating an auto-decoder architecture. In the example modified architecture, the main NeRF backbone network can be conditioned on a per-object latent code z∈ [symbol] ^{D}, as well as the L-dimensional positional encoding γ^{L} (x) (e.g., as in Ben Mildenhall, Pratul Srinivasan, Matthew Tancik, Jonathan Barron, Ravi Ramamoorthi, & Ren Ng, “NeRF: Representing Scenes as Neural Radiance Fields for View Synthesis,” ECCV 405, 405-421 (Springer, 2020).). Mathematically, the density and radiance functions can then be of the form σ(x|z) and c(x|z). The systems and methods can consider a formulation where radiance may not a function of view direction d. These latent codes can be rows from the latent table Z∈ [symbol] ^{K×D}, which the system can initialize to 0^{K×D}, where K is the number of images. The architecture can enable the systems and methods to accurately reconstruct training examples without requiring significant extra computation and memory for an encoder model and can avoid requiring a convolutional network to extract three-dimensional information from the training images. Training the model can follow the same procedure as single-scene NeRF but may draw random rays from all K images in the dataset and can associate each ray with the latent code that corresponds to the object in the image it was sampled from.

In some implementations, the systems and methods can include foreground-background decomposition. For example, a separate model can be used to handle the generation of background details. The systems and methods can use a lower-capacity model C_{bg}(d|z) for the background that predicts radiance on a per-ray basis. The system can then render by combining the background and foreground colors using a transparency value derived from the NeRF density function:

$$C ( p \vert z ) = α ( p \vert z ) \cdot {C}_{N e R F} ( p \vert z ) + ( 1 - α ( p \vert z ) ) \cdot {C}_{b g} ( {d}_{p} \vert z ) \qquad ( 6 )$$

In some implementations, supervising the foreground/background separation may not always be necessary. For example, a foreground decomposition can be learned naturally from solid background color and 360° camera distribution. When a pre-trained module is available for predicting the foreground segmentation of the training images, the systems and methods may apply an additional loss to encourage the transparency of the NeRF volume to be consistent with the prediction:

$${ℒ}_{m a s k} = {𝔼}_{k ∈ \{ 1 … K \} , p ∈ {I}_{k}} [ {( α ( p \vert {z}_{k} ) - {S}_{I} ( p ) )}^{2} ] \qquad ( 7 )$$

where Sₗ(⋅) is the pre-trained image segmenter applied to image Iₖ and sampled at pixel p. When training on face datasets, the systems and methods can employ the MediaPipe Selfie Segmentation for the pre-trained module in (7) and λₘₐₛₖ=1.0.

In some implementations, the systems and methods can include a hard surface loss for realistic geometry. NeRF can fail to explicitly enforce that the learned volumetric function strictly model a hard surface. With enough input images, and sufficiently textured surfaces, multi-view consistency can favor the creation of hard transitions from empty to solid space. Because the field function that corresponds to each latent code may be only supervised from one viewpoint, the limited supervision can often result in blurring of the surface along the view direction. To counter the blurring, the systems and methods can impose a prior on the probability of the weights w to be distributed as a mixture of Laplacian distributions, one with mode around weight zero, and one with mode around weight one:

$$IP ( w ) ∝ {e}^{- \vert w \vert} + {e}^{- \vert 1 - w \vert} \qquad ( 8 )$$

The distribution may be peaky and may encourage a sparse solution where any values of w in the open interval (0,1) to be discouraged. The systems and methods can convert the prior into a loss via:

$${ℒ}_{hard} = - log ( IP ( w ) ) \qquad ( 9 )$$

The magnitude of σ(x) which can satisfy the constraint may depend on the sampling density. Equation (9) can encourage the density to produce a step function that saturates sampling weight over at least one sampling interval, which, by construction, may be appropriate for the scale of scene being modeled. In some implementations, the systems and methods can employ λ_{hard}=0.1 in experiments.

Volume rendering can rely on camera parameters that associate each pixel with a ray used to compute sample locations. In classic NeRF, cameras can be estimated by structure-from-motion on the input image dataset. For the single-view use case, the original camera estimation process may not be possible due to depth ambiguity. To make the method compatible with single-view images, the systems and methods can employ a pre-trained face mesh network (e.g., the MediaPipe Face Mesh pre-trained network module) to extract two-dimensional landmarks that appear in consistent locations for the object class being considered. FIG. 7 can show example network outputs of the five landmarks used for human faces.

The landmark locations can then be aligned with projections of canonical three-dimensional landmark positions with a “shape matching” least-squares optimization to acquire a rough estimate of camera parameters.

In some implementations, the systems and methods can include conditional generation. Given a pre-trained model, the systems and methods can find a latent code z which reconstructs an image which was not present in the training set. As the latent table can be learned in parallel with the NeRF model parameters, the systems and methods can treat the process as a fine-tuning optimization for an additional row in the latent table. The row can be initialized to the mean μ_{Z} over the existing rows of the latent table and may be optimized using the same losses and optimizer as the main model.

Alternatively and/or additionally, the systems and methods can include unconditional generation. For example, to sample novel objects from the space learned by the model, the systems and methods can sample latent codes from the empirical distribution [symbol] defined by the rows of the latent table Z. The systems and methods can model [symbol] as a multivariate Gaussian with mean μ_{Z} and covariance χ_{Z} found by performing principal component analysis on the rows of Z. The systems and methods can observe a trade-off between diversity and quality of samples when sampling further away from the mean of the distribution. Thus, the systems and methods may utilize truncation techniques to control the trade-off.

In some implementations, the systems and methods can include adversarial training to further improve the perceptual quality of images rendered from novel latent codes.

The systems and methods disclosed herein can be utilized to simulate a diverse population of users (fairness) and amplify the effectiveness of personal data thus reducing the need for large scale data collection (privacy).

The generative neural radiance field method for learning spaces of three-dimensional shape and appearance from datasets of single-view images can learn effectively from unstructured, “in-the-wild” data, without incurring the high cost of a full-image discriminator, and while avoiding problems such as mode-dropping that are inherent to adversarial methods.

The systems and methods disclosed herein can include camera fitting techniques for viewpoint estimation. For example, for a class-specific landmarker which provides estimates for M 2D landmarks [symbol] ∈ [symbol] ^{M×2}, the systems and methods can estimate the extrinsics T and (optionally) intrinsics K of a camera, which can minimize the reprojection error between [symbol] a set of canonical 3D positions p∈ [symbol] ^{M×3}. The systems and methods may achieve this by solving the following least-squares optimization:

$${arg min}_{T , K} {‖ ℓ - P ( p \vert T , K ) ‖}^{2} \qquad ( 10 )$$

where P(x|T, K) represents the projection operation for a world-space position vector x into image space. In some implementations, the systems and methods can perform the optimization using the Levenberg-Marquardt algorithm. The canonical positions p may be either manually specified or derived from data. For human faces, the systems and methods may use a predetermined set of positions which correspond to the known average geometry of the human face. For training and testing with the AFHQ dataset (Yunjey Choi, Youngjung Uh, Jaejun Yoo, & Jung-Woo Ha, “Stargan v2: Diverse image synthesis for multiple domains,” CVPR 8188, 8188-8197 (2020).), the systems and methods may perform a version of the above optimization jointly across all images where p is also a free variable and constrained only to obey symmetry.

In some experiments, camera intrinsics may be predicted for human face data but may use fixed intrinsics for AFHQ where the landmarks are less effective in constraining the focal length. For SRN cars (Vincent Sitzmann, Michael Zollhöfer, & Gordon Wetzstein, “Scene Representation Networks: Continuous 3D-Structure-Aware Neural Scene Representations” (ADV. NEURAL INFORM. PROCESS. SYST., 2019).), the experiments can use the camera intrinsics and extrinsics provided with the dataset.

An example architecture of the systems and methods disclosed herein can use a standard NeRF backbone architecture with a few modifications. In addition to the standard positional encoding, the systems and methods can condition the network on an additional latent code by concatenating the additional latent code alongside the positional encoding. For SRN cars and AFHQ, then systems and methods can use the standard 256 neuron network width and 256-dimensional latents for this network, but the systems and methods may increase to 1024 neurons and 2048-dimensional latents for the example high-resolution CelebA-HQ (Tero Karras, Timo Aila, Samuli Laine, & Jaakko Lehtinen, “Progressive Growing of GANs for Improved Quality, Stability, and Variation,” ARXIV, (Feb. 26, 2018), https://arxiv.org/pdf/1710.10196.pdf.) and FFHQ (Tero Karras, Samuli Laine, & Timo Aila, “A style-based generator architecture for generative adversarial networks,” ARXIV (Mar. 29, 2019), https://arxiv.org/pdf/1812.04948.pdf.) models. For the example background model, the systems and methods can use a 5-layer, 256-neuron relu MLP in all cases. During training, the systems and methods can use 128 samples per ray for volume rendering with no hierarchical sampling.

In some implementations, the systems and methods can train each model for 500k iterations using a batch size of 32 pixels per image, with a total of 4096 images included in each batch. For comparison, at 256² image resolution, the compute budget may allow for a batch size of just 2 images for a GAN-based method which renders the entire frame for each image.

Additionally and/or alternatively, the systems and methods can train with an ADAM optimizer using exponential decay for the learning rate from 5×10⁻⁴ to 1×10⁻⁴. The systems and methods may run each training job using 64 v4 Tensor Processing Unit chips, taking approximately 36 hours to complete for the example high resolution models.

### Example Experiments

Example models trained according to the systems and methods disclosed herein can generate realistic view renderings from a single view image. For example, experiments can visualize images rendered from the example models trained on the CelebA-HQ, FFHQ, AFHQ, and SRN Cars datasets. In order to provide quantitative evaluation of the example methods and comparison to state of the art, a number of experiments can be performed.

| Method | PSNR↑ | SSIM↑ | LPIPS↓ | Res. |
|---|---|---|---|---|
| π-GAN (CelebA) | 23.5 | 0.858 | 0.226 | |
| Example (FFHQ) | 29 | 0.913 | 0.199 | 128² |
| Example (CelebA-HQ) | 29.1 | 0.914 | 0.197 | |

Table 1 can be descriptive of results for the reconstructions of training images. The metrics can be based on a subset of 200 images from the π-GAN training set. The example model can achieve significantly higher reconstruction quality, regardless of whether the model is trained on (FFHQ) or (CelebA-HQ).

| Method | PSNR↑ | SSIM↑ | LPIPS↓ | Res. |
|---|---|---|---|---|
| π-GAN (CelebA) | 21.8 | 0.796 | 0.412 | |
| Example (CelebA-HQ) | 26.2 | 0.856 | 0.363 | 256² |
| π-GAN (CelebA) | 20.9 | 0.795 | 0.522 | |
| Example (CelebA-HQ) | 25.1 | 0.831 | 0.501 | 512² |
| Example (FFHQ) | 25.3 | 0.836 | 0.491 | |

Table 2 can be descriptive of results for the reconstructions of test images. Reconstruction quality (rows 1 and 2) of models trained on (CelebA) and (CelebA-HQ) on images from a 200-image subset of FFHQ, and (rows 3-5) of models trained at 256² (Example) and 128² (π-GAN) on high resolution 512² versions of the test images can be shown.

As the example generative neural radiance field model can be trained with an image reconstruction metric, the experiments can include first performing experiments to evaluate how well images from the training dataset are reconstructed. In Table 1, the results can show the average image reconstruction quality of both the example method and π-GAN for a 200-image subset of the π-GAN training set (CelebA), as measured by peak signal to noise ratio (PSNR), structural similarity index measure (SSIM), and learned perceptual image patch similarity (LPIPS). To compare against π-GAN, which may not learn latent codes corresponding to training images, the experiments can use the procedure included with the original π-GAN implementation for fitting images through test-time latent optimization. Because the technique can assume a perfectly forward facing pose, to make the comparison fair, the experiments can augment the technique with the camera fitting method disclosed herein to improve the results on profile-view images. The experiments can further include performing a more direct comparison of image fitting by testing on a set of held out images not seen by the network during training. For example, the experiments can sample a set of 200 images from the FFHQ dataset and can use the latent optimization procedure to produce reconstructions using a model trained on CelebA images. Table 2 can show the reconstruction metrics for these images using example neural radiance field models and π-GAN.

| Method | PSNR↑ | SSIM↑ | Mask-LPIPS↓ |
|---|---|---|---|
| π-GAN (CelebA) | 24.5 | 0.918 | 0.102 |
| Example (CelebA-HQ) | 26.6 | 0.93 | 0.0989 |
| Example (FFHQ) | 27 | 0.931 | 0.0975 |

Table 3 can be descriptive of novel view synthesis results. The experiment can sample pairs of images from one frame for each subject in the HUMBI dataset and can use them as query/target pairs. The query image can be used to optimize a latent representation of the subject's face, which can then be rendered from the target view. To evaluate how well the models have learned the three-dimensional structure of faces, the experiment can then evaluate image reconstruction metrics for the face pixels of the predicted and target images after applying a mask computed from face landmarks.

To evaluate the accuracy of the learned three-dimensional structure, the experiments can perform image reconstruction experiments for synthesized novel views. The models being tested can render these novel views by performing image fitting on single frames from a synchronized multi-view face dataset, Human Multiview Behavioural Imaging (HUMBI), and reconstructing images using the camera parameters from other ground truth views of the same person. The results of the experiment for the example generative neural radiance field model and the π-GAN can be given in Table 3. The experimental results can convey that the example model achieves significantly better reconstruction from novel views, indicating that the example method has indeed learned a better three-dimensional shape space than π-GAN (e.g., a shape space that may be capable of generalizing to unseen data and may be more than simply reproducing the query image from the query view). The results can show qualitative examples of novel views rendered by the example generative neural radiance field model and π-GAN.

| Method | Depth Correlation↑ |
|---|---|
| Ground Truth | 66 |
| AIGN (supervised) | 50.81 |
| DepthNetGAN (supervised) | 58.68 |
| MOFA | 15.97 |
| DepthNetGAN (supervised) | 35.77 |
| UnSup3D | 54.65 |
| Example (CelebA-HQ) | 50.18 |

Table 4 can be descriptive of example depth prediction results. Correlation between predicted and true keypoint depth values on 3DFAW can be conveyed. The experiment can compare the results from supervised and unsupervised methods.

The experiments can further evaluate the shape model of the example models by predicting depth values for images where ground truth depth is available. For the experiments, the models can use the 3DFAW dataset, which provides ground truth 3D keypoint locations. For the task, the experiments can fit latent codes from the example model on the 3DFAW images and can sample the predicted depth values for each image-space landmark location. The experiments can compute the correlation of the predicted and ground truth depth values, which can be recorded in Table 4. While the example model's score may not be as high as the best performing unsupervised method, the example model can outperform several supervised and unsupervised methods specifically designed for depth prediction.

To demonstrate the benefits of being able to train directly on high-resolution images, the experiments can quantitatively and qualitatively compare high-resolution renders from an example generative neural radiance field model trained on 256×256 FFHQ and CelebA-HQ images to those of π-GAN trained on 128×128 CelebA images (the largest feasible size used due to compute constraints). The results can be shown in Table 2. The results can show that for this task the example models do a much better job of reproducing high-resolution detail, even though both methods may be implicit and capable of producing “infinite resolution” images in theory.

To quantify the example method's dependence on large amounts of data, the experiments can include performing an ablation study in which the experiment can train models with subsets of the full dataset. A trade-off in quality of training image reconstruction and quality of the learned three-dimensional structure can be seen as the dataset size increases. Very small datasets can reconstruct their training images with high accuracy but may produce completely unreasonable geometry and novel views. As the number of training images increases, the accuracy of reconstruction may slowly decrease, but the predicted structure may generalize to become much more consistent and geometrically reasonable.

To evaluate the quality of unconditional samples that can be generated using the example PCA-based sampling method, an experiment can compute three standard quality metrics for generative image models on these renders: Frechet Inception Distance (FID), Kernel Inception Distance, (KID), and Inception Score (IS). The experiments can show that an example method can achieve an inception score competitive with other three-dimensional-aware GAN methods, indicating that the systems and methods are able to model a variety of facial appearances. The results for the distribution distance metrics, FID and KID, however, may show opposing results with the example method doing far worse in FID but better in KID. The reason for this may not be entirely clear, but FID may be shown to be sensitive to noise, and details in the peripheral areas of the example generated images show more noise-like artifacts than π-GAN.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for generative neural radiance field model training, the method comprising:
obtaining a plurality of images, wherein the plurality of images depict a plurality of different objects that belong to a shared class;
processing the plurality of images with a landmark estimator model to determine a respective set of one or more camera parameters for each image of the plurality of images, wherein determining the respective set of one or more camera parameters comprises determining a plurality of two-dimensional landmarks in each image;
for each image of the plurality of images:
processing a latent code associated with a respective object depicted in the image with a generative neural radiance field model to generate a reconstruction output, wherein the reconstruction output comprises a volume rendering generated based at least in part on the respective set of one or more camera parameters for the image;
evaluating a loss function that evaluates a difference between the image and the reconstruction output; and
adjusting one or more parameters of the generative neural radiance field model based at least in part on the loss function.

2. The method of claim 1, further comprising:
processing the image with a segmentation model to generate one or more segmentation outputs;
evaluating a second loss function that evaluates a difference between the one or more segmentation outputs and the reconstruction output; and
adjusting one or more parameters of the generative neural radiance field model based at least in part on the second loss function.

3. The method of claim 1, further comprising:
adjusting one or more parameters of the generative neural radiance field model based at least in part on a third loss, wherein the third loss comprises a term for incentivizing hard transitions.

4. The method of claim 1, further comprising:
evaluating a third loss function that evaluates an alpha value of the reconstruction output, wherein the alpha value is descriptive of one or more opacity values of the reconstruction output; and
adjusting one or more parameters of the generative neural radiance field model based at least in part on the third loss function.

5. The method of claim 1, wherein the shared class comprises a faces class.

6. The method of claim 1, wherein a first object of the plurality of different objects comprises a first face associated with a first person, and wherein a second object of the plurality of different objects comprises a second face associated with a second person.

7. The method of claim 1, wherein the shared class comprises a cars class, wherein a first object of the plurality of different objects comprises a first car associated with a first car type, and wherein a second object of the plurality of different objects comprises a second car associated with a second car type.

8. The method of claim 1, wherein the plurality of two-dimensional landmarks are associated with one or more facial features.

9. The method of claim 1, wherein the generative neural radiance field model comprises a foreground model and a background model.

10. The method of claim 1, wherein the foreground model comprises a concatenation block.

11. A computing system generating class-specific view rendering outputs, the system comprising:
one or more processors; and
one or more non-transitory computer-readable media that collectively store instructions that, when executed by the one or more processors, cause the computing system to perform operations, the operations comprising:
obtaining a training dataset, wherein the training dataset comprises a plurality of single-view images, wherein the plurality of single-view images are descriptive of a plurality of different respective scenes;
processing the training dataset with a machine-learned model to train the machine-learned model to learn a volumetric three-dimensional representation associated with a particular class, wherein the particular class is associated with the plurality of single-view images; and
generating a view rendering based on the volumetric three-dimensional representation.

12. The system of claim 11, wherein the view rendering is associated with the particular class, and wherein the view rendering is descriptive of a novel scene that differs from the plurality of different respective scenes.

13. The system of claim 11, wherein the view rendering is descriptive of a second view of a scene depicted in at least one of the plurality of single-view images.

14. The system of claim 11, further comprising:
generating a learned latent table based at least in part on the training dataset; and
wherein the view rendering is generated based on the learned latent table.

15. The system of claim 11, wherein the machine-learned model is trained based at least in part on a red-green-blue loss, a segmentation mask loss, and a hard surface loss.

16. The system of claim 11, wherein the machine-learned model comprises an auto-decoder model.

17. A computer-implemented method for generating a novel view of an object, the method comprising:
obtaining input data, wherein the input data comprises a single-view image, wherein the single-view image is descriptive of a first object of a first object class;
processing the input data with a machine-learned model to generate a view rendering, wherein the view rendering comprises a novel view of the first object that differs from the single-view image, wherein the machine-learned model was trained on a plurality of training images associated with a plurality of second objects associated with the first object class, wherein the first object and the plurality of second objects differ; and
providing the view rendering as an output.

18. The method of claim 17, wherein the input data comprises a position and a view direction, wherein the view rendering is generated based at least in part on the position and the view direction.

19. The method of claim 17, wherein the machine-learned model comprises a landmark model, a foreground neural radiance field model, and a background neural radiance field model.

20. The method of claim 17, wherein the view rendering is generated based at least in part on a learned latent table.

21. (canceled)

22. (canceled)

23. (canceled)
